(19) United States
(12) Patent Application Publication
(10) Pub. No.: US 2014/0292455 A1
(43) Pub. Date: Oct. 2, 2014

(54) Reactor, Transformer, and Power Conversion Apparatus Using Same

(71) Applicants: Naoyuki Kurita, Tokyo (JP); Kazumasa Ide, Tokyo (JP)

(72) Inventors: Naoyuki Kurita, Tokyo (JP); Kazumasa Ide, Tokyo (JP)

(73) Assignee: Hitachi, Ltd., Chiyoda-ku, Tokyo (JP)

(21) Appl. No.: 14/354,107

(22) PCT Filed: Oct. 31, 2011
(86) PCT No.: PCT/JP2011/075021

§ 371 Date: Apr. 24, 2014

(51) Int. Cl. H01F 3/04

(52) U.S. Cl. CPC H01F 3/04
USPC 336/5

(57) ABSTRACT

Either a reactor or a transformer includes two facing yoke cores, and a plurality of magnetic leg cores around which coils are wound and gap adjustment means are disposed. The two facing yoke cores are connected with the plurality of magnetic leg cores, and are provided with isotropic magnetic bodies on at least one of the connection parts. The isotropic magnetic bodies are formed from an isotropic magnetic material. A power conversion apparatus includes either the reactor or the transformer.

### TECHNICAL FIELD

The present invention relates to a reactor and a transformer using a combined iron core, and a power conversion apparatus using the same.

### BACKGROUND ART

In general, the iron cores of a magnetic component of a large capacity reactor device, a transformer, or the like are structured by a laminated iron core obtained by laminating a tape-shaped magnetic material, such as thin silicon steel or amorphous, into plural layers in order to reduce loss (iron loss) during operation.

The iron core of such a magnetic component includes a magnetic leg portion obtained by combining plural laminated iron cores to form magnetic paths to allow a magnetic flux to flow, coils being wound around the iron cores, and a yoke portion that connects magnetic legs each other. When a current is made flow in such a coil, if there is a portion where the direction of the magnetic flux flowing in the laminated iron core and the in-plane direction of the tape-shaped magnetic material do not agree with each other, in-plane eddy currents are induced in the tape-shaped magnetic material at the portion. As a result, eddy current loss is generated in the iron core, and iron loss of the magnetic component increases.

A method of reducing generation of this eddy current loss is described, for example, in Patent Document 1. Patent Document 1 discloses a technology in which grain-oriented steel seat is used for a leg portion for which a coil is wound, and any one of dust core, sintered core, and non-grain-oriented steel seat is used for a yoke portion.

### BACKGROUND ART DOCUMENT

### Patent Document

Patent Document 1: JP 2009-117442 A

### DISCLOSURE OF THE INVENTION

### Problems to be Solved by the Invention

When the same magnetic material for yoke cores and magnetic leg cores are used as conventionally which causes a problem that, as described above, eddy current loss is generated at iron cores and iron loss of magnetic components increases.

Further, by a reactor device (hereinafter, abbreviated as ‘reactor’, as appropriate) with the structure disclosed by Patent Document 1, it is necessary to structure the yoke cores and the magnetic leg cores with different magnetic materials. Accordingly, in the case of usage for iron cores of a large capacity reactor or transformer, two kinds of magnetic materials are used in a large amount, which causes a problem in that the manufacturing cost increases.

Further, in the case that dust core or sintered core is used as the material of yoke cores, as there is a limit in the manufacturable size, there is a problem in that application to the iron cores of a large capacity reactor device or a transformer is difficult.

In this situation, the present invention has been developed to solve such problems, and an object of the invention is to provide a reactor or a transformer that is low in the manufacturing cost and excellent in low loss characteristic, and a power conversion apparatus using the same.

### Means for Solving the Problems

In order to attain the above described object, respective aspects of the invention have the following structures.

That is, a reactor according to the invention includes: two yoke cores facing each other; and plural magnetic leg cores around which respective coils are wound, the magnetic leg cores being provided with gap adjusting means, wherein the two facing yoke cores are connected with each other by the plural magnetic leg cores, and corresponding connecting portions at least on one side are provided with respective isotropic magnetic bodies of an isotropic magnetic material.

Further, a transformer according to the invention includes: two yoke cores facing each other; and plural magnetic leg cores around which respective coils are wound, the magnetic cores being provided with gap adjusting means, wherein the two facing yoke cores are connected with each other by the plural magnetic leg cores, and corresponding connecting portions at least on one side are provided with respective isotropic magnetic bodies of an isotropic magnetic material.

Still further, a power conversion apparatus according to the invention includes the reactor or the transformer.

Yet further, other means will be described in embodiments for carrying out the invention.

### Advantageous Effect of the Invention

According to the invention, it is possible to provide a reactor or a transformer that is low in the manufacturing cost and excellent in the low loss characteristic, and a power conversion apparatus using the same.

### BRIEF DESCRIPTION OF THE DRAWINGS

FIG. 1 is a perspective view showing the structure of a reactor in a first embodiment according to the present invention;

FIG. 2 is a vertical cross-sectional view showing the structure of the reactor in the first embodiment according to the invention;

FIG. 3 is a vertical cross-sectional view showing the structure of a transformer in a second embodiment according to the invention;

FIGS. 4A-4C are diagrams representing the structure and dimensions, the magnetic flux characteristic, definition of a coordinate system in verifying the advantages of the present embodiment by electromagnetic field computation by a finite element method, wherein FIG. 4A shows the structure, the dimensions, and the coordinate system of a connecting portion between a yoke core 1a and a magnetic leg core 3, FIB. 4B is a vector diagram of a magnetic flux B in the magnetic leg core 3 in a vicinity of the connecting portion, and FIG. 4C shows the coordinate system and a perspective view of the connecting portion between the yoke core 1a and the magnetic leg core 3;

FIG. 5 is a characteristic diagram showing the distribution of the θ direction component of the magnetic flux at the connecting surface between a magnetic leg core 3 and a disc-shaped isotropic magnetic body 4 regarding the iron core in the present embodiment with the structure and the dimensions shown in FIGS. 4A-4C, the distribution characteristic being obtained by electromagnetic field computation by a finite element method;

FIGS. 6A and 6B are diagrams showing the structure of a magnetic leg core of a reactor in a third embodiment according to the invention, wherein the magnetic leg core is substantially in a fan shape formed by laminating a tape-shaped magnetic material into plural layers, the layers meanwhile being subjected to insulation;

FIG. 7 is a diagram showing the structure of a magnetic leg core of a reactor in a fourth embodiment according to the invention, wherein the magnetic leg core is substantially in a rectangular parallelepiped shape formed by laminating a tape-shaped magnetic material into plural layers, the layers meanwhile being subjected to insulation;

FIG. 8 is a diagram showing the structure of the fixing device of a reactor in a fifth embodiment according to the invention;

FIG. 9 is a diagram showing a structure wherein a reactor in the present embodiment is provided to a power conversion apparatus in a sixth embodiment according to the invention; and

FIG. 10 is a referential view showing the outline of an example of the structure of a conventional reactor.

### EMBODIMENTS FOR CARRYING OUT THE INVENTION

Embodiments for carrying out the present invention will be described below, referring to the drawings.

### First Embodiment

### Reactor

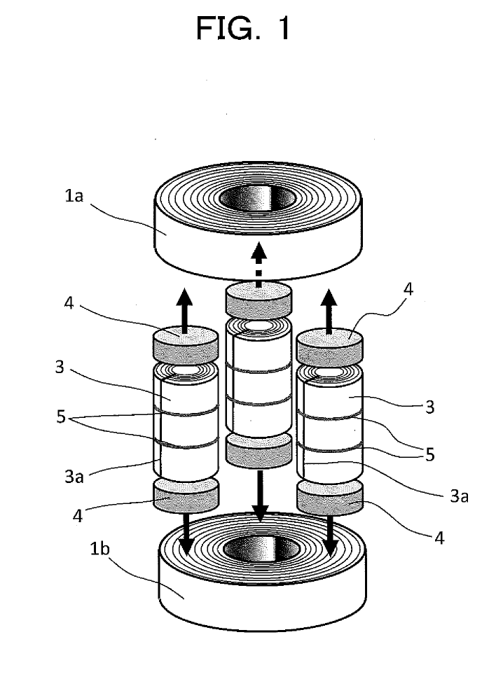

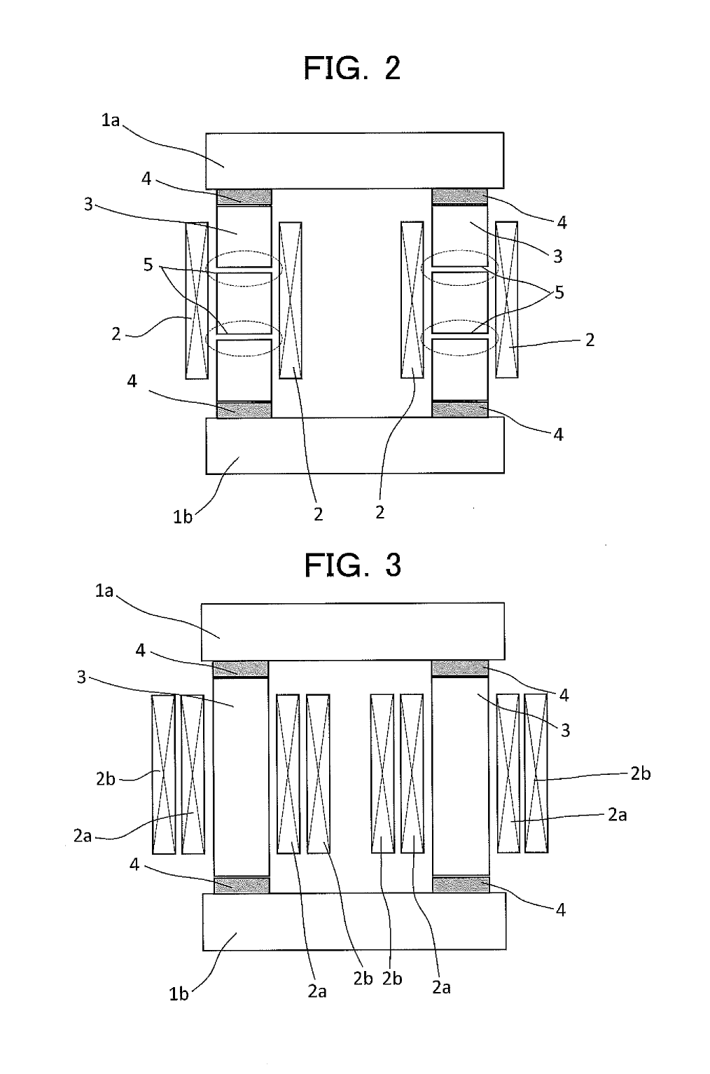

A first embodiment according to the invention will be described below, referring to FIGS. 1 and 2.

FIG. 1 is a perspective view showing the structure of a reactor (reactor device, three-phase reactor device) in a first embodiment. Further, FIG. 1 is also a perspective view showing the structure of a transformer (transformer device, three-phase transformer device) in a second embodiment described later.

FIG. 2 is a vertical cross-sectional view showing the structure of the reactor in the first embodiment.

In FIG. 1, yoke cores 1a, 1b are formed by laminating a tape-shaped magnetic material into plural layers, the layers meanwhile being subjected to insulation, and thus winding the tape-shaped magnetic material substantially into a toroidal shape (annular shape).

Each magnetic leg core 3 is formed by laminating a tape-shaped magnetic material, the magnetic material meanwhile being subjected to insulation, and thus winding the magnetic material substantially into a solid cylindrical shape. The magnetic leg core 3 is provided with a slit 3a, along the vertical direction, at least at one position of the substantially solid cylindrical shape. Further, the magnetic leg core 3 is provided with a gap (spatial gap) by gap adjusting means 5 at at least one position.

The three magnetic leg cores 3 are disposed on a circle at an angle of 120 degrees to each other, and connect the two yoke cores 1a and 1b. Incidentally, the three magnetic leg cores 3 are disposed in the above-described position relationship in order that the reactor device in the present embodiment functions as a three-phase reactor for three-phase alternate current and the electrical symmetry then is ensured.

Further, isotropic magnetic bodies 4 are sandwiched between the magnetic leg cores 3 and the yoke cores 1a, 1b.

The isotropic magnetic bodies 4 are components substantially in a thin-plate shape of an isotropic magnetic material, and are formed by a dust core based on a magnetic metal, a sintered core of a material such as ferrite, or the like. This is because a material having been subjected to a process such as dusting or sintering becomes substantially into a polycrystalline state and thereby tends to have an isotropic characteristic.

Incidentally, FIG. 1 separately shows the yoke cores 1a, 1b, the isotropic magnetic bodies 4, and the magnetic leg cores 3. The arrows in FIG. 1 approximately represent the portions of the yoke cores 1a, 1b and the isotropic magnetic bodies 4, the portions corresponding to each other when the yoke cores 1a, 1b, the isotropic magnetic bodies 4, and the magnetic leg cores 3 are assembled to be connected (joined).

The each iron core constructing a magnetic leg of the reactor in FIG. 1 is, as described above, ‘a combined iron core’ including a magnetic leg core 3, a slit 3a, isotropic magnetic bodies 4, and gap adjusting means 5, however, will be referred to merely as ‘an iron core’, as appropriate, also in the following.

Incidentally, in FIG. 1, the coils 2 shown in FIG. 2 are omitted for the convenience of representation.

In FIG. 2, the yoke cores 1a, 1b, the magnetic leg cores 3, the isotropic magnetic bodies 4, and the gap adjusting means 5 are those described with reference to the perspective view FIG. 1, and are represented by a cross-section from the vertical direction.

In FIG. 1, the yoke cores 1a, 1b, the isotropic magnetic bodies 4, and the magnetic leg cores 3 are separately shown. On the other hand, in FIG. 2, the yoke cores 1a, 1b, the isotropic magnetic bodies 4, and the magnetic leg cores 3 are represented in a state that these are respectively in contact and assembled in FIG. 2.

The magnetic leg cores 3 are shown only in two for the convenience of representation.

In FIG. 2, the coils 2 are wound along the circumferential directions of the substantially solid cylindrical shapes of the magnetic leg cores 3. This structure provides, electrically, the basic structure of the reactor in which coils are wound around iron cores with a high permeability.

Incidentally, the coils 2 are coils for magnetic excitation and are structured by a linearly-shaped conductor or a plate-shaped conductor with an insulation material.

When a current is applied to a coil (coils for magnetic excitation) 2, magnetic flux is generated along the longitudinal direction of the substantially solid cylindrical shape of the magnetic leg core 3, and the magnetic flux cause flows of eddy currents along the circumferential directions of the magnetic leg core 3 to increase the loss as a reactor. Accordingly, in order to prevent flows or generation of such eddy currents, the above-described slit 3a is provided along the longitudinal direction of the magnetic leg core 3 at least at one position.

Further, in order to prevent variation of the inductance value or an increase in the loss caused by magnetic saturation of the magnetic leg core 3, the magnetic leg core 3 is provided with the above-described gap adjusting means 5 at at least one position as shown in FIG. 2 (and FIG. 1). In order to obtain a desired characteristic (saturation characteristic, inductance value) as a reactor, the gap of the gap adjusting means 5 is adjusted in assembling.

As the magnetic flux flowing through the connecting portions between the magnetic leg core 3 and the yoke cores 1a, 1b greatly changes in the direction thereof, the magnetic flux runs across the tape surfaces that structure the iron core to induce in-plane eddy currents at the tape. In order to reduce these eddy currents, the isotropic magnetic bodies 4 are arranged.

The isotropic magnetic bodies 4 are disposed between the magnetic leg core 3 and the yoke cores 1a, 1b. When the direction of the magnetic flux of the magnetic leg core 3 changes substantially by 90 degrees toward the directions of magnetic flux of the yoke cores 1a, 1b, the inside of the isotropic magnetic body 4 takes the change of the direction of the magnetic flux by the characteristic of an isotropic magnetic material.

Thus, change in the magnetic flux at the magnetic leg core 3 and the yoke cores 1a, 1b is decreased so that generation of eddy currents at the magnetic leg core 3 is reduced, which enables reducing the eddy current loss.

The present embodiment has a significant feature in that the isotropic magnetic bodies 4 are arranged between the magnetic leg cores 3 and the yoke cores 1a, 1b.

Incidentally, the change in the magnetic flux at an isotropic magnetic body 4 will be described later in detail.

### Second Embodiment

### Transformer

A second embodiment according to the invention will be described below, referring to FIG. 1 and FIG. 3.

As described above, FIG. 1 is also a perspective view showing the structure of a transformer (transformer device, three-phase transformer device) in a second embodiment. However, in the second embodiment, as the gap adjusting means 5 is not an essential element by a later-described reason, the gap adjusting means 5 is not shown in FIG. 3.

Incidentally, in the case of a large sized transformer, gap adjusting means 5 may be provided as shown in FIG. 1.

FIG. 3 is a vertical cross-sectional view showing the structure of a transformer (transformer device, three-phase transformer device) in the second embodiment.

In FIG. 3, the yoke cores 1a, 1b, the magnetic leg cores 3, and the isotropic magnetic bodies 4 are those described in FIG. 1, which is a perspective view, and are represented by a vertical cross-section.

Further, in FIG. 3, a primary coil 2a is wound in the circumferential direction of the substantially solid cylindrical shape of the each magnetic leg core 3. A secondary coil 2b is wound in the circumferential direction around the primary coil 2a. The primary coil 2a and the secondary coil 2b are structured by a linear-shaped conductor or a plate-shaped conductor with an insulation material.

Herein, the primary coil 2a is a coil for magnetic excitation, and the coil for magnetic excitation is particularly and preferably formed by a linear-shaped conductor or a plate-shaped conductor provided with an insulation member.

Incidentally, in the following, even when a transformer (transformer device, three-phase transformer device) refers to a device, the device is abbreviated and referred to as ‘transformer’, as appropriate.

In FIG. 3, when a current is applied to a primary coil 2a, a current, which corresponds to the magnitude of the load coupled to the electrode of this coil and is in a direction opposite to the current in the primary coil 2a, is induced to cause an action that cancels or weakens the magnetic flux in the magnetic leg core 3, and thus magnetic saturation hardly occurs.

Accordingly, it is not always necessary to provide gap adjusting means (5 in FIG. 2) to the magnetic leg core 3. That is, in FIG. 3, the each magnetic leg core 3 is not provided with gap adjusting means (5 in FIG. 2) and is substantially in an incorporated solid cylindrical shape and is disposed such as to be connected with the yoke cores 1a, 1b.

In a case of a large sized transformer, gap adjusting means (5 in FIG. 1, FIG. 2) may be provided, as described above.

Also in the case of FIG. 3, by providing the isotropic magnetic bodies 4 between magnetic leg cores 3 and the yoke cores 1a, 1b, generation of eddy currents at the magnetic leg cores 3 can be reduced and the loss by eddy currents can be reduced.

### <Advantage of Isotropic Magnetic Body>

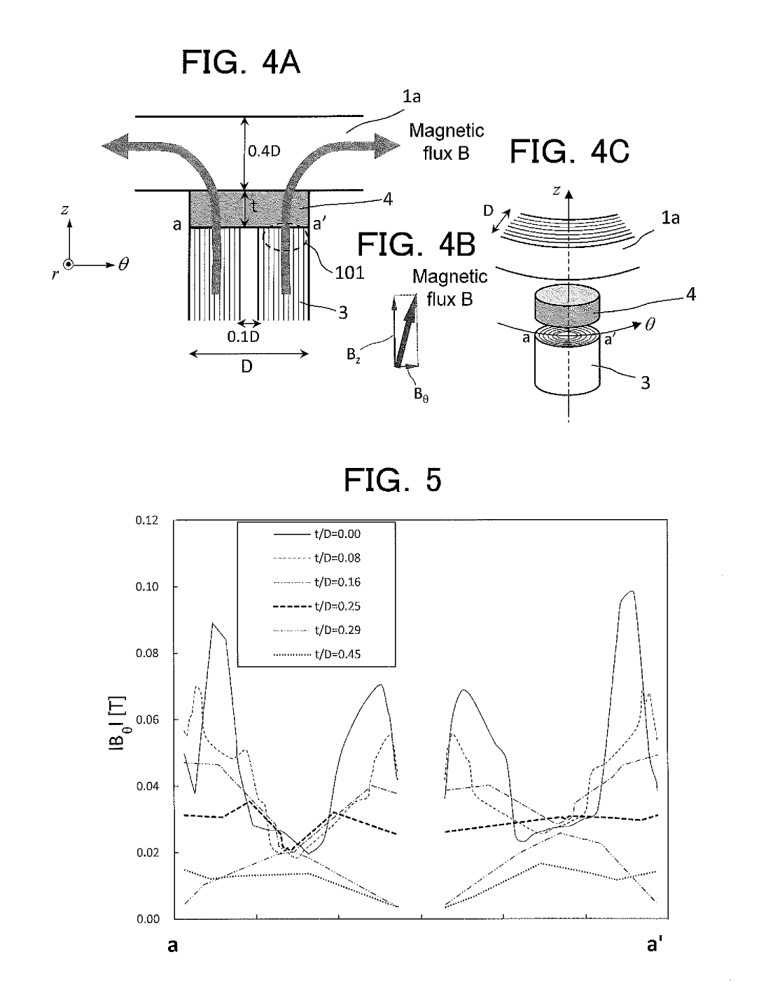

In the following, the advantage of providing the isotropic magnetic bodies 4 between the magnetic leg cores 3 and the yoke cores 1a, 1b in the first and second embodiments will be descried below, referring to FIGS. 4A-4C and FIG. 5.

FIGS. 4A-4C are diagrams representing the structure and dimensions, the magnetic flux characteristic, definition of a coordinate system in verifying the advantages of the present embodiment by electromagnetic field computation by a finite element method, wherein FIG. 4A shows the structure, the dimensions, and the coordinate system of a connecting portion between a yoke core 1a and a magnetic leg core 3; FIB. 4B is a vector diagram of a magnetic flux B in the magnetic leg core 3 in a vicinity of the connecting portion, and FIG. 4C shows the coordinate system and a perspective view of the connecting portion between the yoke core 1a and the magnetic leg core 3.

In FIGS. 4A-4C, a cylindrical coordinate system is defined wherein the circumferential direction of the yoke core 1a is represented by θ, the radial direction is represented by r, and the axial direction of the magnetic leg core 3 is represented by z.

As shown in FIG. 4A and FIG. 4C, a disc-shaped isotropic magnetic body 4 with a thickness of t and a diameter of D is sandwiched at the connecting portion between the yoke core 1a and the magnetic leg core 3. Incidentally, the diameter of the disc-shaped isotropic magnetic body 4 and that of the magnetic leg core 3 are substantially the same, wherein the thickness of the yoke core 1a is 0.4 times the diameter D of the disc-shaped isotropic magnetic body 4, and the width is substantially the same as the above-described diameter D. The diameter of the hollow portion inside the magnetic leg core 3 is 0.1 times the diameter D of the isotropic magnetic body 4.

Incidentally, the fact that the diameter (D) of the disc-shaped isotropic magnetic body 4 and the width (D) of the yoke core 1a are the same corresponds to the fact that the diameter of the magnetic leg core 3 (namely the diameter of the disc-shaped isotropic magnetic body 4) is superimposed substantially with the width of the yoke core 1a.

A magnetic flux B from the magnetic leg core 3 toward the yoke core 1a penetrates through the disc-shaped isotropic magnetic body 4 and proceeds on a path as represented by the arrow shown in FIG. 4A. The direction of the path of the magnetic flux B represented by this arrow changes at the inside portion of the magnetic leg core 3, the portion being adjacent to the yoke core 1a.

That is, as shown in FIG. 4B, the magnetic flux B at the inside portion of the magnetic leg core 3, the inside portion being adjacent to the yoke core 1a, is influenced such as to change in the direction thereof to have a component in direction θ in addition to the component in direction z.

As the magnetic leg core 3 is structured by winding a tape-shaped magnetic material substantially into a solid cylindrical shape wherein direction z is in-plane with respect to the tape-shaped magnetic material, the θ direction component B_{θ} of the magnetic flux B penetrates through the tape-shaped magnetic material to cause eddy current loss.

Conversely, as the direction of the magnetic flux in the yoke core 1a is parallel with the tape surface, eddy current loss occurs little.

In FIG. 4A, as a hollow portion exists at the center of the magnetic leg core 3, the magnetic leg core 3 is more like in ‘a tubed cylindrical shape’ than in ‘a solid cylindrical shape’, however, the magnetic leg core 3 is intentionally represented by ‘a solid cylindrical shape’ because it is ideally desirable that a hollow portion does not exists.

### <Computation Result on Electromagnetic Field by Finite Element Method>

FIG. 5 is a characteristic diagram on the iron core in the present embodiment with the structure and the dimensions shown in FIGS. 4A-4C, wherein distribution of absolute value |B_{θ}| of the component in direction θ of the magnetic flux, which is along the center line a-a′ in the direction θ at the connecting surface between the magnetic leg core 3 and the disc-shaped isotropic magnetic body 4, is obtained by computation of the electromagnetic filed by a finite element method.

In FIG. 5, the horizontal axis represents the position on the center line a-a′ in direction θ at the connecting surface between the magnetic leg core 3 and the disc-shaped isotropic magnetic body 4, and the vertical axis represents the absolute value |B_{θ}| (unit is [T] (T: Tesla, density of magnetic flux) of the component in direction θ of the magnetic flux.

Incidentally, the blank portion with no data values shown in the vicinity of the substantial center of FIG. 5 corresponds to the hollow portion at the center of the magnetic leg core 3 in FIGS. 4A-4C. As no iron core exists at this hollow portion, this hollow portion is a region excluded from computation.

In this computation, the diameter D of the disc-shaped isotropic magnetic body 4 shown in FIGS. 4A-4C is made constant; the thickness t of the disc-shaped isotropic magnetic body 4 is changed; the thickness t of the isotropic magnetic body 4 is gradually increased from a condition that the disc-shaped isotropic magnetic body 4 does not exist (t/D=0.00) to conditions that t/D=0.08, t/D=0.16, t/D=0.25, t/D=0.29, and t/D=0.45; and computation (simulation) results of six cases with respective parameter t/D are shown.

In FIG. 5, the computation results of these six cases are shown as characteristic curves by various kinds of representation, such as a solid line, a dashed line, and an alternate long and short dash curve.

Incidentally, magnetomotive force of the coil is set such that the average value of the z-direction component Bz of the magnetic flux inside the magnetic leg core 3 becomes 0.82 [T]. The magnetic saturation characteristics of the magnetic leg core 3, the yoke core 1a, and the isotropic magnetic body 4 were computed on assumption that all of the characteristics are the same as that of Metglas amorphous tape 2605SA1 by Hitachi Metals, Ltd.

If the disc-shaped isotropic magnetic body 4 does not exist, in other words, t=0, accordingly t/D=0, the maximum value of the absolute value |B_{θ}| of the component in direction θ of the magnetic flux is obtained as results of the computation (simulation) in the above-described six cases.

It is presumed that this is a result of the fact that, when an isotropic magnetic body 4 does not exist, |B_{θ}| in the vicinity of the outermost circumferential portion and in the vicinity of the hollow portion of the inside of the magnetic leg core 3 increases, and eddy current loss particularly and significantly tends to increase by penetration of magnetic flux through the tape surfaces of tape-shaped magnetic material.

In contrast, under conditions that t/D=0.08, t/D=0.16, t/D=0.25 in FIG. 5, which corresponds to increasing the thickness t of the disc-shaped isotropic magnetic body 4, |B_{θ}| becomes smaller as the value of t/D increases.

This corresponds to the fact that increase in |B_{θ}| at the connecting surface between the magnetic leg core 3 and the isotropic magnetic body 4 is reduced by increasing the thickness t of the disc-shaped isotropic magnetic body 4.

It is recognized from the characteristic diagram in FIG. 5 that under condition t/D=0.29, |B_{θ}| in the vicinity of the outermost circumferential portion and the vicinity of the hollow portion inside the magnetic leg core increases little, and under condition t/D=0.45, |B_{θ}| further decreases.

Accordingly, if t/D=0.29 or larger, it is expected that generation of eddy current loss of the magnetic leg core 3 can be almost inhibited.

In other words, this means that the larger the thickness (t) of the isotropic magnetic body 4, the larger the effect.

Incidentally, the above-described effect can be obtained both for a reactor and a transformer.

### Third Embodiment

### Reactor

A third embodiment (reactor) according to the invention will be described below.

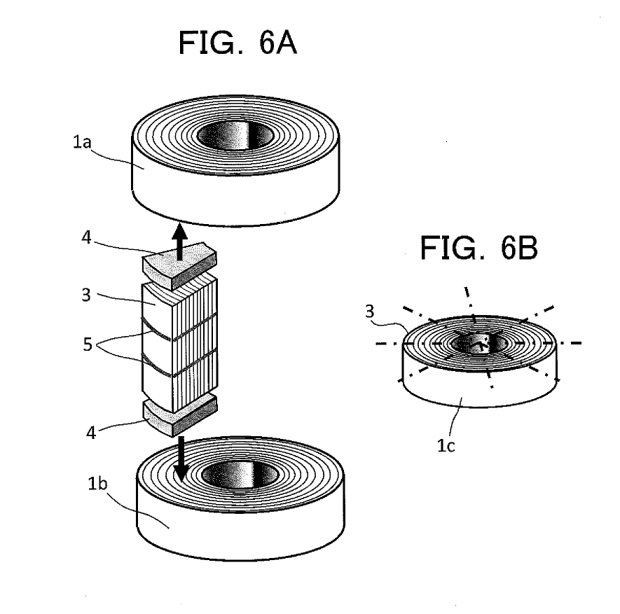

FIGS. 6A and 6B are diagrams showing the structure of a magnetic leg core 3 around which a coil 2 is wound, in a third embodiment according to the invention, wherein the magnetic leg core 3 is substantially in a fan shape formed by laminating a tape-shaped magnetic material into plural layers, the layers meanwhile being subjected to insulation.

In FIGS. 6A and 6B, magnetic leg core 3 is shown only in one, however, three magnetic leg cores may be arranged as shown in FIG. 1. The difference of FIGS. 6A and 6B from FIG. 1 is that the magnetic leg core 3 is substantially in a fan shape.

The magnetic leg core 3 substantially in a fan shape is formed, for example, by cutting a toroidal shape core 1c with an appropriate angle along the moving radius direction, wherein the toroidal core 1c is formed by laminating a tape-shaped magnetic material into plural layers, the layers meanwhile being subjected to insulation, and winding the tape-shaped magnetic material into a toroidal shape.

Compared with the case of the magnetic leg cores 3 substantially in a solid cylindrical shape in FIG. 1, as a magnetic leg core 3, as shown in FIGS. 6A and 6B, is substantially in a fan shape, the efficiency in the occupied area of magnetic leg cores 3 at the central portions of three magnetic leg cores 3 is improved in case that the magnetic leg cores 3 are arranged in three. Further, in case that the magnetic leg cores 3 are substantially in a fan shape, the lamination directions of the tape-shaped magnetic material of the yoke cores 1a, 1b and the lamination directions of the magnetic leg cores 3 come to easily agree with each other. Making a three-phase reactor device has features that the structure becomes compact and low loss characteristic can be easily obtained

Further, accompanying the substantial fan shape of the magnetic leg cores 3, the connecting portion between the magnetic leg cores 3 and the yoke cores 1a, 1b are provided with isotropic magnetic bodies 4 substantially in a fan shape with the same cross-sectional shape as those of the magnetic leg cores 3 and in a thin plate shape with a certain thickness.

Incidentally, it is desirable, from the point of view of improving the electrical characteristics, that the lamination direction of the tape-shaped magnetic material of the magnetic leg cores 3 is set to be the same as the lamination direction of the yoke cores 1a, 1b and to be the moving radius direction.

Further, the third embodiment has been described for a reactor device, by providing primary coils 2a (FIG. 3) and secondary coils 2b (FIG. 3), a transformer or a three-phase transformer having the same structure of magnetic leg cores 3 can be configured.

Incidentally, points, other than that the magnetic leg cores 3 are substantially in a fan shape, are common to FIGS. 6A and 6B and FIG. 1 with exception described above, wherein, for example, the yoke cores 1a, 1b, the disposition substantially at 120 degrees on the circumference of the yoke cores 1a, 1b, and the gap adjusting means 5 are common, and overlapping description will be omitted.

### Fourth Embodiment

### Reactor

In the following, a fourth embodiment (reactor) according to the invention will be described.

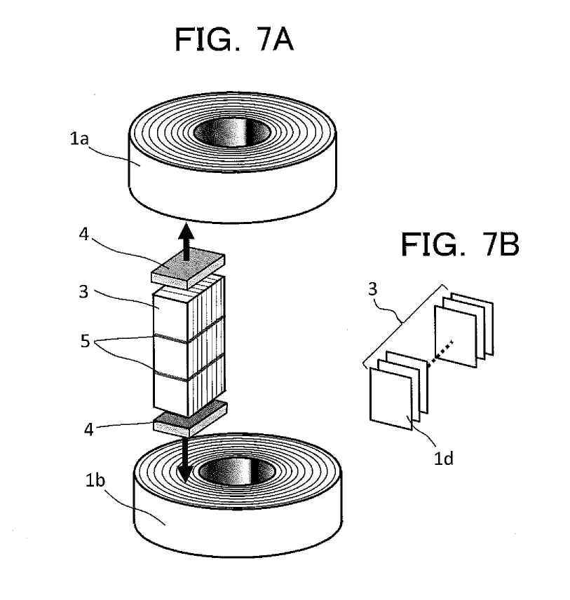

FIG. 7 is a diagram showing a structure where a magnetic leg core 3, around which a coil 2 is wound, is substantially in a rectangular parallelepiped shape formed by laminating a tape-shaped magnetic material 1d into plural layers, the layers meanwhile being subjected to insulation.

In FIG. 7, the magnetic leg core 3 is shown only in one, however, the magnetic leg core may be in three as shown in FIG. 7. The difference of FIG. 7 from FIG. 1 and FIGS. 6A and 6B is that the magnetic leg core 3 is in a rectangular parallelepiped shape.

The magnetic leg core 3 is formed, for example, by laminating a tape-shaped magnetic material 1d, the tape-shaped magnetic material 1d meanwhile being subjected to insulation, and cutting the lamination into a certain size. By forming a rectangular parallelepiped shape, effects may be obtained for downsizing, reduction in the number of processes in the manufacturing process, and reduction in the manufacturing cost of a reactor device.

Further, accompanying the substantially rectangular parallelepiped shape of the magnetic leg core 3, the connecting portions between the magnetic leg core 3 and the yoke cores 1a, 1b are provided with isotropic magnetic bodies 4 substantially in a rectangular parallelepiped shape with the same cross-sectional shape as that of the magnetic leg core 3 and in a thin plate shape with a certain thickness.

Incidentally, it is preferable that the lamination direction of the tape-shaped magnetic material of the magnetic leg core 3 is the same as the lamination direction of the yoke cores 1a, 1b, and is the moving radius direction.

Further, the third embodiment has been described for a reactor device, by providing primary coils 2a (FIG. 3) and secondary coils 2b (FIG. 3), a transformer or a three-phase transformer having the same structure of magnetic leg cores 3 can be configured.

Incidentally, points, other than that the magnetic leg cores 3 are substantially in a fan shape, are common to FIG. 7 and FIG. 1 with exception described above, and overlapping description will be omitted.

### Fifth Embodiment

### Reactor

In the following, a fifth embodiment (reactor, reactor device) according to the invention will be described.

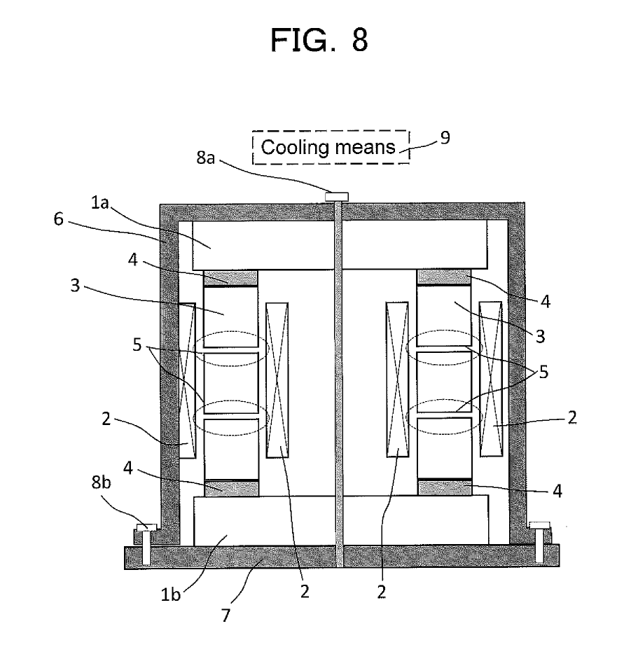

FIG. 8 is a diagram showing the structure of the fixing device of a reactor device in a fifth embodiment according to the invention. Incidentally, the above-described first, third, and fourth embodiments can be applied to the reactor device itself other than the structure of the fixing device.

In FIG. 8, the reactor device (1a, 1b, 2, 3, 4, and 5) is mounted on a base 7, covered by a fixing jig 6 from above, and is pressure-fixed by fixing means 8a, 8b.

The base 7 and the fixing jig 6 may be formed by a plate-shaped member that perfectly covers the reactor device, or may be formed by a frame-shaped member that does not perfectly cover the reactor device.

Further, as necessary, cooling means 9 may be provided on the concentric axis of the yoke cores 1a, 1b.

Incidentally, in the above, FIG. 8 shows the reactor device (1a, 1b, 2, 3, 4, and 5) provided with plural gap adjusting means 5 at a magnetic leg core 3, as an example, however, the structural example of the fixing device shown in the present embodiment can be applied to the transformer device in the second embodiment shown in FIG. 3, by exactly the same configuration.

### Sixth Embodiment

### Power Convertor

In the following, as a sixth embodiment according to the invention, a power conversion apparatus using the reactor in the above-described embodiment will be described.

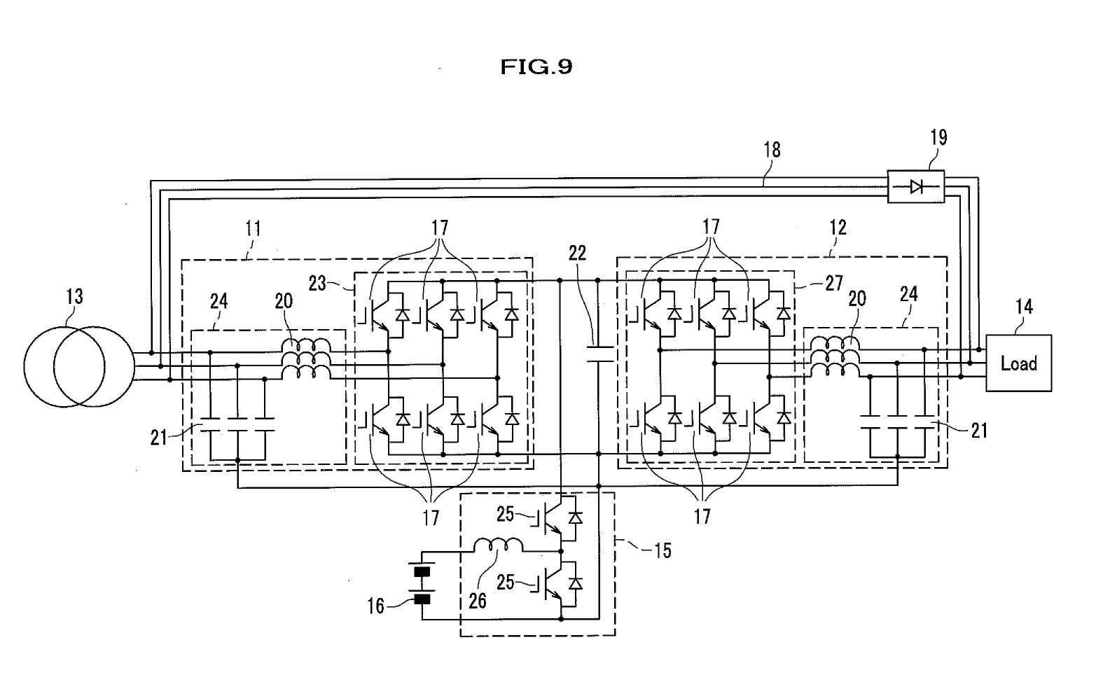

FIG. 9 shows the structure of a power conversion apparatus in a sixth embodiment according to the invention, and is a circuit diagram wherein the reactor described in the first and third to fifth embodiments is applied to the power conversion apparatus. The circuit diagram shown in FIG. 9 shows the circuit configuration of the power conversion apparatus as an online typed three-phase uninterruptible power system.

In FIG. 9, the power conversion apparatus is provided between an AC power source 13 and a load 14.

Further, the power conversion apparatus is provided with a rectifying circuit 11 for converting AC power of the AC power source 13 to DC power, and an inverter circuit 12 for converting DC power to AC power with an arbitrary voltage and an arbitrary frequency. Still further, a filtering condenser 22 and a chopper circuit 15 are connected between the output terminal of the rectifying circuit 11 and the input terminal of the inverter circuit 12.

The rectifying circuit 11 is provided with a filter circuit 24, the filter circuit 24 having a three-phase reactor 20 and a three-phase capacitor 21, and an AC/DC convertor circuit 23 (bridge circuit) that bridge-connects switching devices 17, which are plural IGBTs (Insulated Gate Bipolar Transistors) being semiconductor devices.

The inverter circuit 12 is provided with a DC/AC convertor circuit 27 (bridge circuit) that bridge-connects switching devices 17, which are plural IGBTs, and a filter circuit 24 having a three-phase reactor 20 and a three-phase capacitor 21.

Incidentally, the switching devices 17 configured by plural IGBTs of the AC/DC convertor circuit 23 and the DC/AC convertor circuit 27 are integrally subjected to PWM (Pulse Width Modulation) from the respective gate terminals to execute the above-described respective desired functions.

Further, to the respective IGBT switching devices 17, diodes for protecting against overvoltage are added or parasitized, being connected in inverse parallel.

Further, as the three-phase reactors 20 of the filter circuits 24 of the rectifying circuit 11 and the inverter circuit 12, any one of the reactors in the first and third to fifth embodiments is used.

Further, in the chopper circuit 15, switching devices 25 of two IGBTs (25) are serially connected, wherein the switching devices 25 are connected to the terminals of the smoothing capacitor 22. To the connection point between the two switching devices 25, one end of a coil or a reactor 26 is connected, and a battery 16 is connected between the other end of the coil or the reactor 26 and the emitter of one switching device 25.

During normal operation of the above-described power conversion apparatus, the rectifying circuit 11 converts AC power from the AC power source 13 to DC power, and the inverter circuit 12 again converts the DC power to AC power with an arbitrary voltage and an arbitrary frequency suitable for the load 14 to transmit the AC power to the load 14.

Further, as operation (operation 1 other than normal operation) not during normal operation, when power supply from the AC power source 13 is cut off, the chopper circuit 15 works to connect the battery 16 and the inverter circuit 12, and power, which is supplied from the battery 16 and converted by the inverter circuit 12 to AC power, is continuously supplied to the load 14.

Further, as operation (operation 2 other than normal operation) during maintenance time or the like, a bypass circuit 18 provided with a bypass convertor circuit 19 is connected to the load 14, and AC power is supplied from the AC power source 13 to the load 14 not through the rectifying circuit 11 nor the inverter circuit 12.

Incidentally, to which extent the bypass circuit 18 provided with the bypass convertor circuit 19 should have function depends on the specifications of the power conversion apparatus.

As described above, the rectifying circuit 11 has a function of an AC/DC convertor circuit for conversion of three-phase AC power to DC power, and the inverter circuit 12 has a function of a DC/AC convertor circuit for conversion of DC power into three-phase AC power with an arbitrary voltage and an arbitrary frequency.

In these conversions, both the rectifying circuit 11 and the inverter circuit 12 operate plural switching devices for PWM control. In the process of these switching operations, harmonic components (ripple components) are generated.

The filter circuits 24 are used for removing these harmonic components and impedance matching between the AC power source 13 and the AC/DC convertor circuit 23 forming a bridge circuit and between the load 14 and the DC/AC convertor circuit 27 forming a bridge circuit.

As described above, the each filter circuit 24 is, as described above, configured by using the three-phase reactor 20 and the three-phase capacitor 21. Any one of the reactors (devices) in the above described first embodiment and the third to fifth embodiments is used for this three-phase reactor 20.

By using reactors in the present embodiment, a power conversion apparatus with an excellent low loss characteristic and a low manufacturing cost can be realized and provided.

### Other Embodiments

The invention is not limited to the above-described embodiment. Examples will be described below.

Referring to the above-described FIGS. 1 to 3, FIGS. 6A and 6B, or FIG. 7, embodiments have been described where an isotropic magnetic body 4 is provided both between a magnetic leg core and a yoke core 1a and between the magnetic leg core and a yoke core 1b, however, even by providing an isotropic magnetic body 4 at one portion, namely either on the yoke core 1a side or on the yoke core 1b side, effect can be obtained to reduce eddy current loss.

Further, the magnetic leg cores 3, shown in FIG. 1, FIGS. 6A and 6B, or FIG. 7, is an example of a solid cylindrical shape, a fan shape, or a rectangular parallelepiped shape formed by laminating a tape-shaped magnetic material, however, a reactor device may be structured by an arbitrary combination of magnetic leg cores in these shapes.

Further, referring to FIGS. 6A and 6B showing the third embodiment, as a forming method of a magnetic leg core 3 substantially in a fan shape, it has been described ‘by cutting an iron core with an appropriate angle along the moving radius direction, wherein the iron core has been formed by winding a tape-shaped magnetic material into a toroidal shape, the magnetic material meanwhile being subjected to insulation’. However, any other method may be adopted as long as a shape substantially in a fan shape, as shown in FIGS. 6A and 6B, can be obtained.

In FIGS. 6A and 6B, the third embodiment, that is, the effect of the substantial fan shape of a magnetic leg core 3 of a reactor has been described, however, a similar effect is also obtained for a magnetic leg core of a transformer.

In FIG. 7, the fourth embodiment, that is, the effect of the substantial rectangular parallelepiped shape of a magnetic leg core 3 of a reactor has been described, however, a similar effect is also obtained for a magnetic leg core of a transformer.

Further, only three magnetic legs are represented for the three-phase reactor device in FIG. 1. However, also for a three-phase reactor device provided with zero-phase magnetic leg cores (not shown) as paths for flowing magnetic flux by zero-phase impedance are provided between these three magnetic legs, providing an isotropic magnetic body between a magnetic leg core and a yoke core is effective to reduce eddy current loss.

Still further, three magnetic legs for three phases are shown for the reactor device in FIG. 1, however, without being limited to three phases, also in a case of exceeding three phases (for example, five phases), providing an isotropic magnetic body between a magnetic leg core and a yoke core is effective to reduce eddy current loss also on a reactor device having plural magnetic legs exceeding three magnetic legs.

The switching devices 17 of semiconductor devices configuring the AC/DC convertor circuit 23 and the DC/AC convertor circuit 27 of the power conversion apparatus shown in FIG. 9 have been described as IGBTs, the switching devices 17 are not limited to IGBTs.

The switching devices 17 may be configured by MOSFETs (Metal-Oxide-Semiconductor Field-Effect Transistors), bipolar transistors (Bipolar Junction Transistors), or BiCMOS (Bipolar Complementary Metal Oxide Semiconductors), which are switching devices of semiconductor devices.

As application of a reactor device in an embodiment according to the invention, an example of an uninterruptible power system has been described in FIG. 9, however, the above described application is not limited thereto. By using a reactor device, according to the invention, for a filter circuit of a power conversion apparatus for other purposes using a bridge circuit, a conversion apparatus with a low loss can be provided.

Further, in FIG. 9, an example of embodiment, in which a reactor device according to the present embodiment is provided on a power conversion apparatus, has been described, however, it is also possible to provide a transformer in the present embodiment on a power conversion apparatus.

### <Referential Example of Conventional Reactor Device>

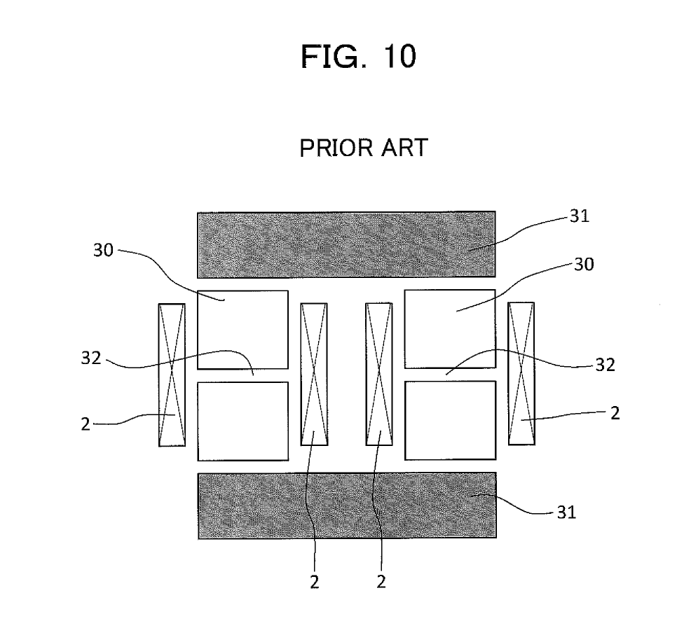

FIG. 10 is a referential view showing the outline of the vertical cross-section of the structure of a conventional reactor (reactor device).

In FIG. 10, the reactor device is configured by yoke cores 31, magnetic leg cores 30, gap adjusting means 32, and coils 2.

The magnetic leg cores 30 and the yoke cores 31 are connected directly or through a gap. Accordingly, the direction of magnetic fluxes generated by the flow of currents in the coils 2 changes from the vertical direction in the magnetic leg cores 30 to the horizontal direction in the yoke cores 31. Accordingly, in the magnetic leg cores 30 in the vicinity of the connecting portions between the magnetic leg cores 30 and the yoke cores 31, magnetic flux with a horizontal direction component is generated in addition to magnetic flux with a vertical direction component, and eddy currents flow along the circumferential direction of the magnetic leg cores 3 so that loss as a reactor increases.

That is, with the structure of the conventional reactor (reactor device) shown in FIG. 10, loss caused by generation of eddy currents is significant.

### Supplement to the Invention and the Present Embodiment

As has been described above, according to the invention, by providing an isotropic magnetic body between a magnetic leg core and a yoke core, generation of eddy currents at the magnetic leg core can be prevented, and reduction in the eddy current loss generated at the iron core can be realized. Consequently, a reactor or a transformer that is low in the manufacturing cost and excellent in the low loss characteristic, compared with a conventional reactor or transformer using conventional iron cores, and a power conversion apparatus using it can be provided.

Furthermore, as it is not necessary to use a dust core nor a sintered core as the material of a yoke core as in the case of Patent Document 1, which is a conventional technology, it is possible to manufacture an iron core enabling easy production and matching a large capacity, and a reactor device or a transformer device with a large capacity and a low loss can be realized and provided.

### DESCRIPTION OF REFERENCE SYMBOLS

1a, 1b, 31: yoke core
1c: toroidal core
1d: tape-shaped magnetic body
2: coil
2a: primary coil
2b: secondary coil
3, 30: magnetic leg core
3a: slit
4: isotropic magnetic body
5, 32: gap adjusting means
6: fixing jig
7: base
8a, 8b: fixing means
9: cooling means
11: rectifying circuit
12: inverter circuit
13: AC power source
14: load
15: chopper circuit
16: battery
17, 25: switching device, IGBT
18: bypass circuit
19: bypass convertor circuit
20, 26: reactor, reactor device
21: capacitor
22: smoothing capacitor
23: AC/DC convertor circuit (bridge circuit)
24: filter circuit
27: DC/AC convertor circuit (bridge circuit)

1. A reactor, comprising:
two yoke cores facing each other; and
plural magnetic leg cores around which respective coils are wound, the magnetic leg cores being provided with gap adjusting means,
isotropic magnetic bodies of an isotropic magnetic material, wherein the two facing yoke cores are connected with each other by the plural magnetic leg cores, and corresponding connecting portions at least on one side are provided with respective isotropic magnetic bodies of an isotropic magnetic material.

2. The reactor according to claim 1,
wherein the isotropic magnetic bodies are formed by a dust core with a primary component of magnetic metal, or a sintered core of ferrite or the like.

3. The reactor according to claim 1,
wherein the each isotropic magnetic body is substantially in a thin plate shape having a shape in a cross-section in a direction parallel with a contact surface of the isotropic magnetic body with the corresponding magnetic leg core, the shape of the thin plate being substantially the same as a shape in a cross-section in the direction of the magnetic leg core.

4. The reactor according to claim 1,
wherein the plural magnetic leg cores are disposed substantially on a circumference of a circle at a certain angular interval.

5. The reactor according to claim 1,
wherein the each yoke core is formed by winding a tape-shaped magnetic material substantially into a toroidal shape.

6. The reactor according to claim 1,
wherein the each of the plural magnetic leg cores is formed by winding a tape-shaped magnetic material substantially into a solid cylindrical shape, and is provided with a slit at at least one portion with respect to a longitudinal direction of the solid cylindrical shape.

7. The reactor according to claim 3,
wherein thickness of the each isotropic magnetic body substantially in the thin plate-shape is larger than or equal to 0.29 times a diameter of the cross-section of the isotropic magnetic body, the cross-section being in the direction parallel with the contact surface of the isotropic magnetic body with the corresponding magnetic leg core.

8. The reactor according to claim 1,
wherein the each of the plural magnetic leg cores is substantially in a rectangular parallelepiped shape formed by laminating a tape-shaped magnetic material into plural layers.

9. The reactor according to claim 1,
wherein the each of the plural magnetic leg cores is substantially in a fan shape with a certain vertex angle, the fan shape being obtained by winding a tape-shaped magnetic material into a toroidal shape and cutting the toroidal shape along a direction of a moving radius of the toroidal shape.

10. The reactor according to claim 1,
wherein the plural magnetic leg cores and the two yoke cores are formed by laminating respective tape-shaped magnetic materials,
and wherein respective lamination directions are the same.

11. The reactor according to claim 1,
wherein the coils are formed by a linear-shaped conductor or a plate-shaped conductor provided with an insulation member.

12. The reactor according to claim 1,
wherein the reactor is connected together with a capacitor to a bridge circuit configured by semiconductor devices to configure a filter circuit,
and wherein the filter circuit has a function to remove a harmonic current component generated from the bridge circuit.

13. A transformer, comprising:
two yoke cores facing each other; and
plural magnetic leg cores around which respective coils are wound,
wherein the two facing yoke cores are connected with each other by the plural magnetic leg cores, and corresponding connecting portions at least on one side are provided with respective isotropic magnetic bodies of an isotropic magnetic material.

14. The transformer according to claim 1,
wherein the isotropic magnetic bodies are formed by a dust core with a primary component of magnetic metal, or a sintered core of ferrite or the like.

15. The transformer according to claim 14,
wherein the plural magnetic leg cores are disposed substantially on a circumference of a circle at a certain angular interval.

16. The transformer according to claim 14,
wherein the each yoke core is formed by winding a tape-shaped magnetic material substantially into a toroidal shape.

17. The transformer according to claim 14,
wherein the each of the plural magnetic leg cores is formed by winding a tape-shaped magnetic material substantially into a solid cylindrical shape, and is provided with a slit at at least one portion with respect to a longitudinal direction of the solid cylindrical shape.

18. The transformer according to claim 14,
wherein the yoke cores are pressure-fixed from above and below by a fixing jig,
and wherein the transformer comprises cooling means on a concentric axis of the yoke cores.

19. A power conversion apparatus, comprising the reactor according to claim 1.

20. A power conversion apparatus, comprising the transformer according to claim 13.
